(19) United States
(12) Patent Application Publication
(10) Pub. No.: US 2025/0123955 A1
(43) Pub. Date: Apr. 17, 2025

(54) PROGRAMMABLE WRITE FILTER HARDWARE

(71) Applicant: Intel Corporation, Santa Clara, CA (US)

(72) Inventors: Frank T. Hady, Cannon Beach, OR (US); Scott D. Peterson, Beaverton, OR (US); Andrzej Stasiak, Borkowo (PL)

(73) Assignee: Intel Corporation, Santa Clara, CA (US)

(21) Appl. No.: 19/001,843

(22) Filed: Dec. 26, 2024

Related U.S. Application Data
(60) Provisional application No. 63/683,465, filed on Aug. 15, 2024.
(60) Provisional application No. 63/654,463, filed on May 31, 2024.

(51) Int. Cl. G06F 12/02; G06F 12/0815

(52) U.S. Cl. CPC G06F 12/0223; G06F 12/0815

(57) ABSTRACT

Write filter hardware is provided with circuitry to receive a signal to switch the write filter from a disabled state to an enabled state for a given range of addresses in a shared memory. A write attempt by a host processor to the range of addresses is identified, where access to the shared memory is shared with an accelerator device. The write filter hardware causes the write attempt to be dropped when the hardware write filter is in the enabled state for the given range of addresses.

### RELATED APPLICATIONS

This application claims the benefit of and priority from U.S. Provisional Patent Application Ser. No. 63/683,465, filed Aug. 15, 2024, entitled “PROGRAMMABLE WRITE FILTER HARDWARE,” and from U.S. Provisional Patent Application Ser. No. 63/654,463, filed May 31, 2024, entitled “PROGRAMMABLE WRITE FILTER HARDWARE,” the disclosures of which are considered part of and hereby incorporated by reference in their entirety in the disclosure of this application.

### BACKGROUND

A datacenter may include one or more platforms, where the platforms include at least one processor and associated memory modules. Platforms in the datacenter may facilitate the performance of any suitable number of processes associated with various applications running on the platform. These processes may be performed by the processors and other associated logic of the platforms. Platforms may additionally include I/O controllers, such as network adapter devices, which may be used to send and receive data on a network for use by the various applications.

### BRIEF DESCRIPTION OF THE FIGURES

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a simplified block diagram illustrating example components of a data center.

FIG. 2 is a simplified block diagram of an example computing system including example computing clusters.

FIG. 3A illustrates a simplified block diagram of an example computing system utilizing a link compliant with a Compute Express Link (CXL)-based protocol.

FIG. 3B illustrates a simplified block diagram of example protocol circuitry.

FIGS. 4A-4C are simplified block diagrams illustrating example device types within a Compute Express Link (CXL) infrastructure.

FIG. 5 is a simplified block diagram illustrating an example data center cluster architecture.

FIG. 6 is a simplified block diagram illustrating data transfers within an example data center cluster architecture.

FIG. 7 is a simplified block diagram illustrating an example memory device coupled to a host processor device by an interconnect.

FIG. 8 is a simplified block diagram illustrating an example memory processing unity (MPU).

FIG. 9 is a simplified block diagram illustrating use of an example programmable write filter device.

FIG. 10 is a simplified block diagram illustrating an example system including a programmable write filter device.

FIG. 11 illustrates a block diagram of an example processor device in accordance with certain embodiments.

Like reference numbers and designations in the various drawings indicate like elements.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

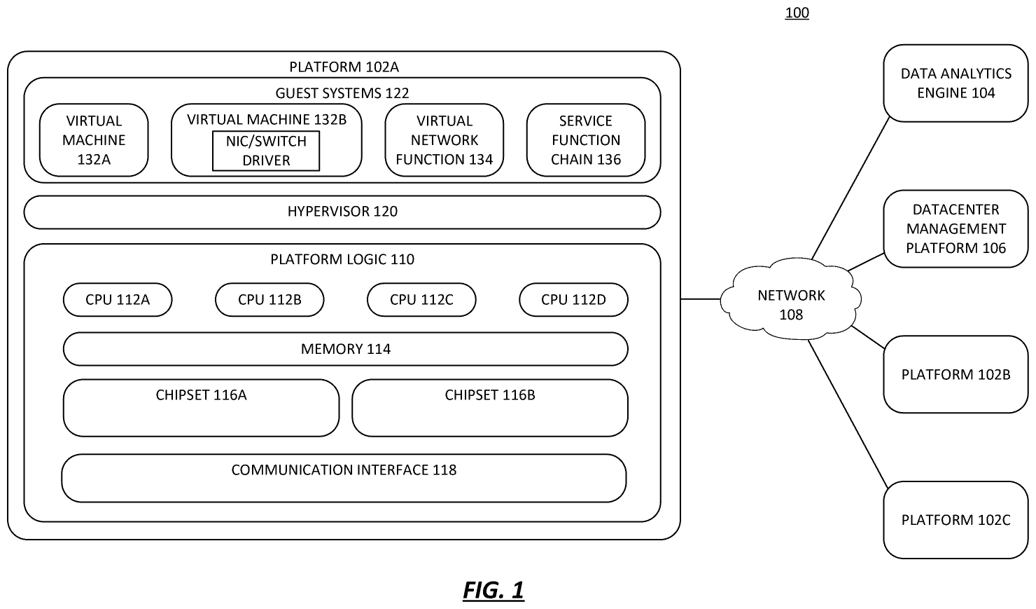

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such clusters more efficient, among other example enhancements.

Computing platforms 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compassable servers, disaggregated servers, or other suitable structures that comprises multiple platforms coupled together through network 108 (which may comprise, e.g., a rack or backplane switch).

CPUs 112 may include any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may include memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. A chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on the CPUs.

Chipsets 116 may include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. A platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the datacenter 100 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

In an improved system implementation, a data center cluster may be implemented utilizing the CXL-based communication channels. For instance, a CXL-based data center cluster may include a number of host computers coupled to a CXL-based switch. Traffic within the cluster and between clusters may be implemented utilizing a network processor device (e.g., a smart network interface controller (NIC), data processing unit (DPU), infrastructure processing unit (IPU), programmable networking device, etc.), which is connected to the CXL-based switch. Local memory of the network processor device may be utilized to construct a shared memory pool for the cluster, which can be leveraged to facilitate efficient data transfers utilizing CXL. CXL enables a more efficient data transmission than TCP and RDMA between the processors and accelerators of the cluster. The network processor device may be configured with logic (implemented in hardware, firmware, and/or software) to perform near-data processing for the cluster and reduce the memory movement, to thereby provide more efficient performance in an improved service mesh cluster architecture. Such an architecture can be used to implement data center clusters with reduced memory movement between hosts, lower latency, improved resource utilization, and lower power consumption, among other example benefits.

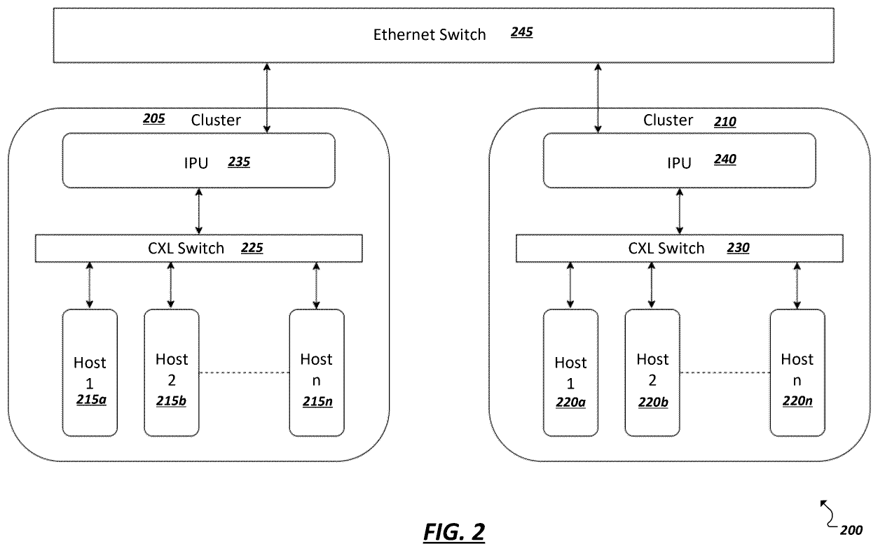

Networking processing devices, such as IPUs, smart NICs, or other network processing elements may be utilized within computing systems to enhance the performance of elements within a computing network, system, or platform. For instance, FIG. 2 is a simplified block diagram 200 illustrating an example implementation of an improved data center cluster architecture. In this example, clusters 205, 210 are shown, the clusters implemented to include respective host computing devices (e.g., 215a-n, 220a-n) coupled to a switch 225, 230 in the cluster 205, 210. A cluster 205, 210 may further include a network interface device (e.g., an IPU or smart NIC) 235, 240 to manage the corresponding cluster (e.g., 205, 210). Further, the network interface devices (e.g., 235, 240) of the various clusters (e.g., 205, 210) may be interconnected with other network interface devices of other clusters, for instance, using an Ethernet or other interconnect. For instance, one or more switches (e.g., Ethernet switch 245) may be utilized to facilitate such an inter-cluster network.

As shown in the example of FIG. 2, a single service mesh cluster (e.g., 205) may be equipped with a switch 225 (e.g., a CXL switch) and network interface device 235, and the servers (e.g., hosts 215a-n) belonging to this cluster are connected to the CXL switch 225 and network interface device 235. The scalability of host servers may vary from cluster to cluster, with clusters capable of including various numbers of host server system based on the dimensions of the CXL switch (e.g., implemented as one rack of servers or multiple racks, etc.). A service mesh may be composed of one cluster or multiple interconnected clusters, such as illustrated in the example of FIG. 2. Cross-cluster connections are managed by the network interface device through the inter-cluster switch (e.g., 245). Additionally, the cluster's network interface device (e.g., 235, 240) may be additionally tasked with handling the ingress and egress traffic of the cluster and distribute the requests between the host servers (e.g., 215a-n) inside the cluster (e.g., 205). In some implementations, microservices may be hosted by various host server systems within an example service mesh, among other example applications.

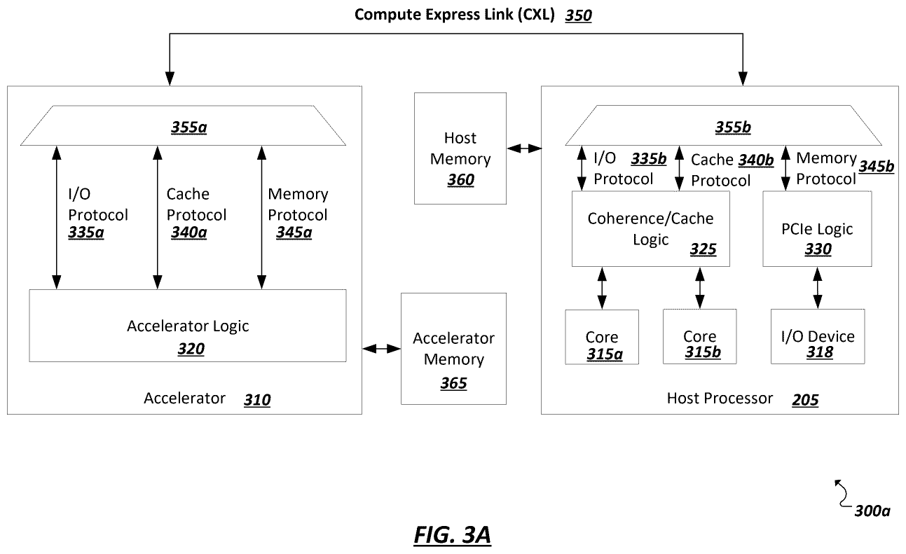

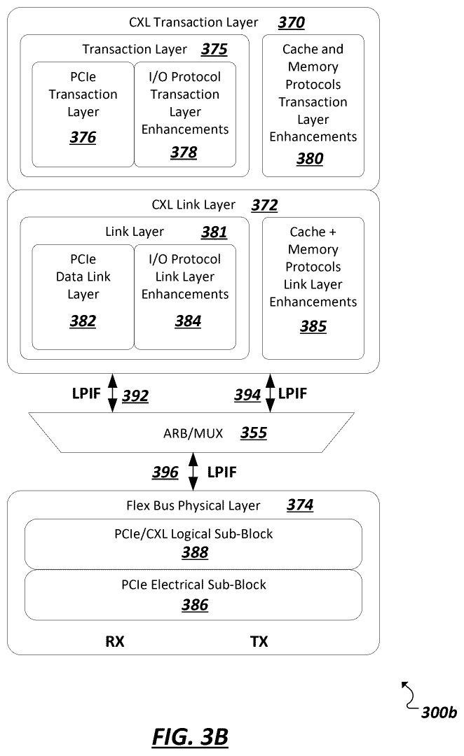

Various interconnect protocols may be utilized to interconnect network interface devices with other computing devices in a cluster. In some implementations, Compute Express Link (CXL)-based protocols may be utilized to enhance performance of communications between devices coupled point-to-point or within a network. FIGS. 3A-3B are simplified block diagrams illustrating example protocol logic, implemented in hardware and/or software, to implement a Compute Express Link (CXL) protocol (e.g., in one or more ports of a device within a system). It should be appreciated, that while much of the discussion centers on features provided by a CXL-protocol and communication channels compliant with CXL, that other substitute protocols with similar, comparable features may be substituted for CXL in the embodiments discussed below. The CXL interconnect protocol is designed to provide an improved, high-speed CPU-to-device and CPU-to-memory interconnect designed to accelerate next-generation data center performance, among other applications. CXL maintains memory coherency between the CPU memory space and memory on attached devices, which allows resource sharing for higher performance, reduced software stack complexity, and lower overall system cost, among other example advantages. CXL enables communication between host processors (e.g., CPUs) and a set of workload accelerators (e.g., graphics processing units (GPUs), field programmable gate array (FPGA) devices, tensor and vector processor units, machine learning accelerators, networking accelerators, purpose-built accelerator solutions, among other examples). Indeed, CXL is designed to provide a standard interface for high-speed communications, as accelerators are increasingly used to complement CPUs in support of emerging computing applications such as artificial intelligence, machine learning and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a dynamic multi-protocol technology designed to support a vast spectrum of accelerators. CXL provides a rich set of sub-protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0, PCIe 6.0, etc.), leveraging the PCIe physical and electrical interface to provide advanced protocol in areas include I/O, memory protocol (e.g., allowing a host processor to share memory with an accelerator device), and coherency interface.

Turning to FIG. 3A, a simplified block diagram 300a is shown illustrating an example system utilizing a CXL link 350. For instance, the link 350 may interconnect a host processor 305 (e.g., CPU) to an accelerator device 310. In this example, the host processor 305 includes one or more processor cores (e.g., 315a-b) and one or more I/O devices (e.g., 318). Host memory (e.g., 360) may be provided with the host processor (e.g., on the same package or die). The accelerator device 310 may include accelerator logic 320 and, in some implementations, may include its own memory (e.g., accelerator memory 365). In this example, the host processor 305 may include circuitry to implement coherence/cache logic 325 and interconnect logic (e.g., PCIe logic 330). CXL multiplexing logic (e.g., 355a-b) may also be provided to enable multiplexing of CXL protocols (e.g., I/O protocol 335a-b (e.g., CXL.io), caching protocol 340a-b (e.g., CXL.cache), and memory access protocol 345a-b (CXL.mem)), thereby enabling data of any one of the supported protocols (e.g., 335a-b, 340a-b, 345a-b) to be sent, in a multiplexed manner, over the link 350 between host processor 305 and accelerator device 310.

In some implementations, a Flex Bus™ port may be utilized in concert with CXL-compliant links to flexibly adapt a device to interconnect with a wide variety of other devices (e.g., other processor devices, accelerators, switches, memory devices (e.g., near memory, far memory, pooled memory, tiered memory, cache, etc.), among other examples). A Flex Bus port is a flexible high-speed port that is statically configured to support either a PCIe or CXL link (and potentially also links of other protocols and architectures). A Flex Bus port allows designs to choose between providing native PCIe protocol or CXL over a high-bandwidth, off-package link. Selection of the protocol applied at the port may happen during boot time via auto negotiation and be based on the device that is plugged into the slot. Flex Bus uses PCIe electricals, making it compatible with PCIe retimers, and adheres to standard PCIe form factors for an add-in card.

FIG. 3B is a simplified block diagram 300b illustrating an example protocol stack and associated logic (implemented in hardware and/or software) utilized to implement CXL links. For instance, the protocol logic may be organized as multiple layers to implement the multiple protocols supported by the port. For instance, a port may include transaction layer logic (e.g., 370), link layer logic (e.g., 372), and physical layer logic (e.g., 374) (e.g., implemented all or in-part in circuitry). For instance, a transaction (or protocol) layer (e.g., 370) may be subdivided into transaction layer logic 375 that implements a PCIe transaction layer 376 and CXL transaction layer enhancements 378 (for CXL.io) of a base PCIe transaction layer 376, and logic 380 to implement cache (e.g., CXL.cache) and memory (e.g., CXL.mem) protocols for a CXL link. Similarly, link layer logic 372 may be provided to implement a base PCIe data link layer 382 and a CXL link layer (for CXl.io) representing an enhanced version of the PCIe data link layer 384. A CXL link layer 372 may also include cache and memory link layer enhancement logic 385 (e.g., for CXL.cache and CXL.mem).

Continuing with the example of FIG. 3B, a CXL link layer logic 372 may interface with CXL arbitration/multiplexing (ARB/MUX) logic 355, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 374 based on a PCIe physical layer (e.g., PCIe electrical PHY 386). For instance, a Flex Bus physical layer may be implemented as a converged logical physical layer 388 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., x16, x8, x4, x2, x1, etc.). In PCIe mode, links implemented by the port may be fully compliant with native PCIe features (e.g., as defined in the PCIe specification), while in CXL mode, the link supports the features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transactions involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Controller and the Mem device is regarded as the CXL.mem Subordinate. The CXL.mem Controller is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

In some implementations, an interface may be provided to couple circuitry or other logic (e.g., an intellectual property (IP) block or other hardware element) implementing a link layer (e.g., 372) to circuitry or other logic (e.g., an IP block or other hardware element) implementing at least a portion of a physical layer (e.g., 374) of a protocol. For instance, an interface based on a Logical PHY Interface (LPIF) specification to define a common interface between a link layer controller, module, or other logic and a module implementing a logical physical layer (“logical PHY” or “logPHY”) to facilitate interoperability, design and validation re-use between one or more link layers and a physical layer for an interface to a physical interconnect, such as in the example of FIG. 3B. Additionally, as in the example of FIG. 3B, an interface may be implemented with logic (e.g., 381, 385) to simultaneously implement and support multiple protocols. Further, in such implementations, an arbitration and multiplexer layer (e.g., 355) may be provided between the link layer (e.g., 372) and the physical layer (e.g., 374). In some implementations, each block (e.g., 355, 374, 381, 385) in the multiple protocol implementation may interface with the other block via an independent interface (e.g., 392, 394, 396). In cases where bifurcation is supported, each bifurcated port may likewise have its own independent interface, among other examples.

CXL is a dynamic multi-protocol technology designed to support accelerators and memory devices. CXL.io is for discovery and enumeration, error reporting, peer-to-peer (P2P) access to CXL memory and host physical address (HPA) lookup. CXL.cache and CXL.mem protocols may be implemented by various accelerator or memory device usage models. An important benefit of CXL is that it provides a low-latency, high-bandwidth path for an accelerator to access the system and for the system to access the memory attached to the CXL device. The CXL 2.0 specification enabled additional usage models, including managed hot-plug, security enhancements, persistent memory support, memory error reporting, and telemetry. The CXL 2.0 specification also enables single-level switching support for fan-out as well as the ability to pool devices across multiple virtual hierarchies, including multi-domain support of memory devices. The CXL 2.0 specification also enables these resources (memory or accelerators) to be off-lined from one domain and on-lined into another domain, thereby allowing the resources to be time-multiplexed across different virtual hierarchies, depending on their resource demand. Additionally, the CXL 3.0 specification doubled the bandwidth while enabling still further usage models beyond those introduced in CXL 2.0. For instance, the CXL 3.0 specification provides for PAM-4 signaling, leveraging the PCIe Base Specification PHY along with its CRC and FEC, to double the bandwidth, with provision for an optional flit arrangement for low latency. Multi-level switching is enabled with the CXL 3.0 specification, supporting up to 4K Ports, to enable CXL to evolve as a fabric extending, including non-tree topologies, to the Rack and Pod level. The CXL 3.0 specification enables devices to perform direct peer-to-peer accesses to host-managed device memory (HDM) using Unordered I/O (UIO) (in addition to memory-mapped I/O (MMIO)) to deliver performance at scale. Snoop Filter support can be implemented in Type 2 and Type 3 devices to enable direct peer-to-peer accesses using the back-invalidate channels introduced in CXL.mem. Shared memory support across multiple virtual hierarchies is provided for collaborative processing across multiple virtual hierarchies, among other example features.

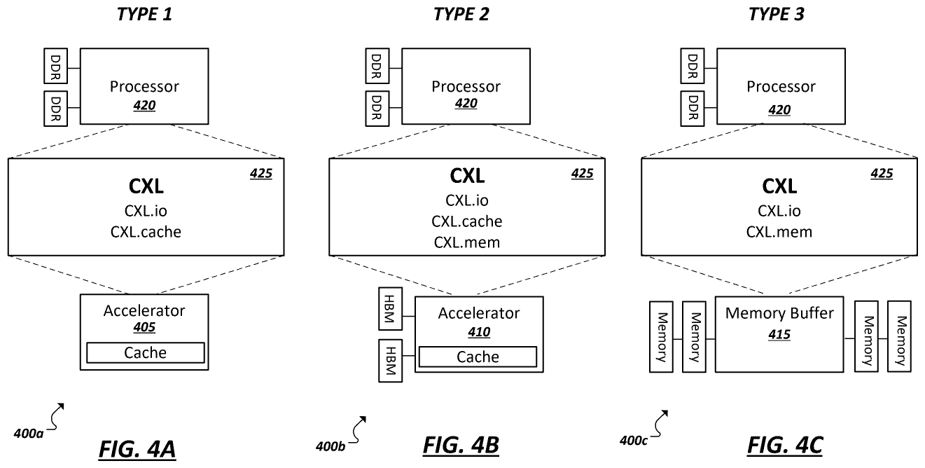

CXL may be used to interconnect peripheral devices that can be either traditional non-coherent I/O devices, memory devices, or accelerators with additional capabilities. When Type 2 and Type 3 device memory is exposed to the host, it is referred to as Host-managed Device Memory (HDM). The coherence management of this memory may be Host-only Coherent (HDM-H), Device Coherent (HDM-D), and Device Coherent using Back-Invalidation Snoop (HDM-DB). The host and device must have a common understanding of the type of HDM for each address region. FIGS. 4A-4C are simplified block diagrams 400a-c showing examples of CXL Type 1 devices (e.g., 405), Type 2 devices (e.g., 410), and Type 3 devices (e.g., 415). A CXL device (e.g., 405, 410, 415) may couple to a host processor (e.g., 420) via a CXL interconnect 425. Different CXL device types may utilize different combinations of the CXL protocols (or sub-protocols) (e.g., CXL.io, CXL.mem, CXL.cache).

In CXL, a “Type 1” devices have special needs for which having a fully coherent cache in the device becomes valuable. For such devices, standard producer-consumer ordering models do not work well. One example of a device with special requirements is to perform complex atomics that are not part of the standard suite of atomic operations present on PCIe. Basic cache coherency allows an accelerator to implement any ordering model it chooses and allows it to implement an unlimited number of atomic operations. These tend to require only a small capacity cache which can easily be tracked by standard processor snoop filter mechanisms. The size of cache that can be supported for such devices depends on the host's snoop filtering capacity. CXL supports such devices using its optional CXL.cache link over which an accelerator can use CXL.cache protocol for cache coherency transactions.

CXL “Type 2” devices, in addition to fully coherent cache, also have memory, for example DDR, High-Bandwidth Memory (HBM), or other memory attached to the device. These devices execute against memory, but their performance comes from having massive bandwidth between the accelerator and device-attached memory. One goal for CXL is to provide a means for the Host to push operands into device-attached memory and for the Host to pull results out of device-attached memory such that it does not add software and hardware cost that offsets the benefit of the accelerator. Systems may include coherent system address-mapped device-attached memory, also referred to as HDM with Device Managed Coherence (HDM-D/HDM-DB). There is an important distinction between HDM and traditional I/O and PCIe Private Device Memory (PDM). An example of such a device is a GPGPU with attached GDDR. Such devices have treated device-attached memory as private. This means that the memory is not accessible to the Host and is not coherent with the remainder of the system. It is managed entirely by the device hardware and driver and is used primarily as intermediate storage for the device with large data sets. A disadvantage to a model such as this is that it involves high-bandwidth copies back and forth from the Host memory to device-attached memory as operands are brought in and results are written back. Please note that CXL does not preclude devices with PDM.

At a high level, there are two example approaches of resolving device coherence of HDM. The first uses CXL.cache to manage coherence of the HDM and is referred to as “Device coherent.” The memory region supporting this flow is indicated with the suffix of “D” (HDM-D). The second approach uses the dedicated channel in CXL.mem called Back Invalidation Snoop and is indicated with the suffix “DB” (HDM-DB). With HDM-DB, the protocol enables new channels in the CXL.mem protocol that allow direct snooping by the device to the host using a dedicated Back-Invalidation Snoop (BISnp) channel. The response channel for these snoops is the Back-Invalidation Response (BIRsp) channel. The channels allow devices the flexibility to manage coherence by using an inclusive snoop filter tracking coherence for individual cache lines that may block (e.g., discard, drop, or otherwise prevent completion of) new M2S Requests until BISnp messages are processed by the host.

A CXL “Type 3” device supports CXL.io and CXL.mem protocols. An example of a CXL Type 3 Device is a memory expander for the Host. Since this is not a traditional accelerator that operates on host memory, the device does not make any requests over CXL.cache. A passive memory expansion device would use the HDM-H memory region and while not directly manipulating its memory while the memory is exposed to the host. The device operates primarily over CXL.mem to service requests sent from the Host. The CXL.io protocol is used for device discovery, enumeration, error reporting and management. The CXL.io protocol is permitted to be used by the device for other I/O-specific application usages. The CXL architecture is independent of memory technology and allows for a range of memory organization possibilities depending on support implemented in the Host. Type 3 device Memory that is exposed as an HDM-DB enables the device to directly manage coherence with the host to enable in-memory computing and direct access using UIO on CXL.io. A Type 3 Multi-Logical Device (MLD) can partition its resources into up to multiple (e.g., 16) isolated Logical Devices. A Logical Device may be identified by a Logical Device Identifier (LD-ID) in CXL.io and CXL.mem protocols. A Logical Device visible to a Virtual Hierarchy (VH) may operate as a Type 3 device. The LD-ID is transparent to software. MLD components have common Transaction and Link Layers for each protocol across the LDs.

CXL is capable of maintaining memory coherency between the CPU memory space and memory on attached devices, so that any of the CPU cores or any of the other I/O devices configured to support CXL may utilize these attached memories and cache data locally on the same. Further, CXL allows resource sharing for higher performance, such that memory pooling may be achieved across different computing entities. Such CXL-enabled memory pools may enable enhanced and more efficient movement of operands. For instance, rather than utilizing DMA operations to transfer an entire segment of data from one computing element to the next computing element in association with a corresponding operation, coherent memory allows data to be moved seamlessly as if it were a simple transfer between the different cores in different CPU sockets. Such memory pooling can thus realize significant latency reduction and enable this aggregated memory in the system. Such features can enable more efficient memory usage, reduced architectural complexity, and thereby lower overall system costs. Further, such features allow programmers and system developers to focus on target workloads as opposed to redundant memory management, among other example benefits.

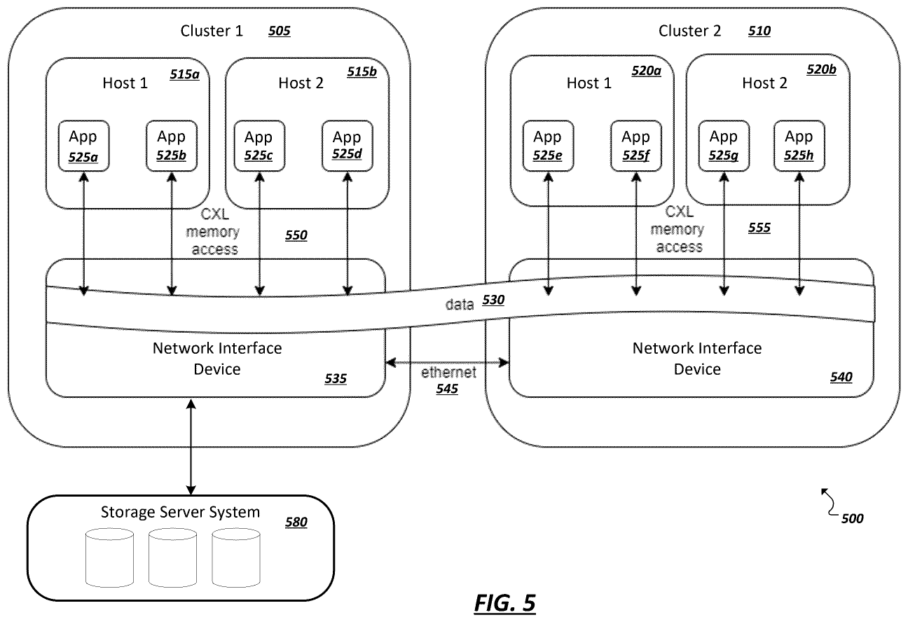

Improved node or cluster architectures may leverage the combined features of CXL and smart network interface devices (e.g., IPUs) to develop more efficient and better-performing service mesh clusters, which achieve these efficiencies with minimal movement of networking data and enhanced near memory processing. Such improved clusters can realize smaller latency, better resources utilization, and lower power consumption, among other example benefits. FIG. 5 is a simplified block diagram 500 illustrating a logical view of such a portion of such an improved cluster. As introduced above, a service mesh can be composed of one or multiple clusters (e.g., 505, 510). Host devices (e.g., 515a, 515b, 520a, 520b, etc.) may host various programs, services, microservices, or applications (e.g., 525a-h), which are executed on the corresponding host, and which may share and operate various data on the service mesh. The data 530 moving within the cluster (e.g., including from memory and other compute resources from a storage server system 580) may be handled using the corresponding cluster's network interface device (e.g., 535, 540), with the network interface device further handling the inter-cluster communications and the internal connections of hosts and the network interface device within the cluster. Attached memory of the network interface device may be utilized to implement a memory pool for the cluster. Accordingly, data used in transactions within the cluster may be saved in the memory pool on the network interface device. Accordingly, when host device accesses the data within a transaction, the host device can utilize CXL memory accesses (e.g., 550, 555) to directly read or write data through the CXL cached memory as if it were local memory.

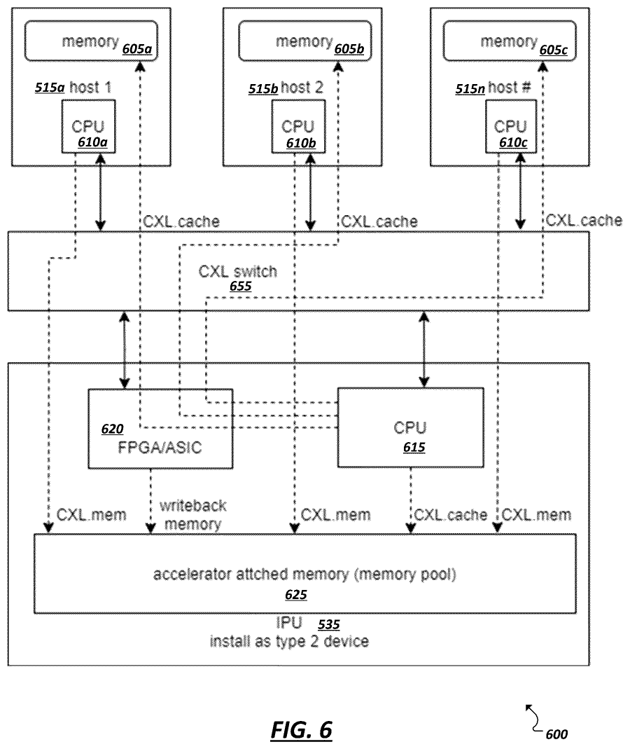

Turning to FIG. 6, a simplified block diagram 600 illustrating example hardware blocks of components within a cluster, such as the example shown in FIG. 5. For instance, a host device (e.g., 515a-n) may include respective local or attached memory (e.g., 605a-c) as well respective processing hardware 610a-c (e.g., CPU, FPGA, GPU, tensor processing unit (TPU), accelerator hardware, etc.), which may be utilized to host and execute various applications or portions of applications on the corresponding host. The host devices 515a-c may be connected to a CXL switch 655 for the cluster. The network interface device 535 of the cluster is also coupled to the switch 655. The network interface device 535 may include both a CPU 615 and programmable processing block 620 (e.g., a field programmable gate array (FPGA) or application-specific integrated circuit (ASIC)), together with attached memory 625, at least a portion of which is designated for use as a memory pool for the cluster.

In one example implementation, the network interface device 535 may be installed as a CXL type 2 device. Accordingly, the CPUs (e.g., 610a-c) of the hosts 515a-c, as well as the CPU (e.g., 615) of the network interface device 535, can cache (e.g., perform cacheable reads and cacheable writes of) the attached memory of the network interface device 535 using the CXL.mem subprotocol. The programmable processing block 620 of the network interface device 535 may cache the hosts' attached memory (e.g., 605a-c) using the CXL.cache subprotocol. Further, a dedicated hardware channel may be provided between the CPU 615 and programmable processing block 620 of the network interface device 535, allowing the CPU 615 to access the hosts' memories (e.g., 605a-c) through the programmable processing block 620 (e.g., also using the CXL.cache subprotocol), among other example features and implementations.

Data centers and data center networks continue to grow in prevalence and performance capabilities as cloud computing and other distributed computing architectures and systems grow in prevalence. With data center network speeds reaching 100 Gps and continuing to increase, conventional communication protocols may not be able to keep pace. For instance, the transmission control protocol (TCP) may struggle to provide the performance that cloud service providers need or desire to provide their respective services (e.g., infrastructure as a service (IaaS), software as a service (Saas), platform as a service (PaaS), etc.). For instance, TCP may not be generally suited for latency sensitive processing due to its congestion management and retransmission control features, among other example issues. Further, data movement between memory, processors, and I/O devices struggle to meet the demands of memory intensive applications using traditional protocols.

Workloads handled by distributed computing architectures also continue to evolve. New workloads and applications challenge traditional data center assumptions and architectures. For instance, modern workloads may correspond to a set of microservices with various memory and bandwidth needs, with modern data centers struggling to accommodate dynamic changes in system configurations optimal for these various workloads and/or inefficiencies in reconfiguring system resources quickly between what can be short-lived microservice workloads. As additional examples, evolving machine learning and tensor processing workloads may require vastly different workloads from other more traditional applications. Data center designers traditionally face a choice: how to outfit a datacenter that is future proof and that can handle a wide range of applications or, alternatively, possesses specialized or custom capabilities optimized for select workload types.

Features of CXL and clusters and networks implemented using CXL offer a number of enhancements in how servers within a datacenter can communicate. Technologies like RDMA, that facilitate direct access of a remote node's memory, introduced the concept of availing direct access to a remote node's memory resources. Now, with CXL, this pushes the limits further by enabling modular system building to effectively plug-and-play various computing resources (e.g., caching devices/accelerators, accelerators with memory, and memory buffers) from a remote node to a given node. To accomplish such a system, however, considerations such as performance impacts, coherence requirements, quality of service, and other factors are to be considered and the system components configured accordingly. Modern system hardware lacks the logic to facilitate such system building.

In an improved system implementation, a data center cluster may be implemented utilizing CXL-based communication channels. For instance, a CXL-based data center cluster may include a number of host or endpoint computing devices (e.g., host devices, CPUs, graphic processors units (GPUs), tensor processing units (TPUs), hardware accelerators (e.g., accelerators for data compression, machine learning, deep learning, matrix processing, etc.), etc.) coupled to a network processor device (e.g., a smart NIC, data processing unit (DPU), IPU, programmable networking device, etc.). The network interface device may be utilized to accelerate the handling of network and memory traffic between the host devices and various remote resources. The network processor device may include a programmable processing block (e.g., an FPGA) to include the implementation of a network interface controller (NIC) that couples to these remote resources. The network interface device may additionally include a system on chip, CPU, or other processor to handle acceleration of network and memory handling. endpoint Traffic within the cluster and between clusters may be implemented and facilitated utilizing, which is connected to or even incorporates the CXL-based switch for the cluster. Local memory of the network processor device may be utilized to construct a shared memory pool for the cluster, which can be leveraged to facilitate efficient data transfers utilizing CXL. CXL enables a more efficient data transmission than TCP and RDMA between the processors and accelerators of the cluster. The network processor device may be configured with logic (implemented in hardware, firmware, and/or software) to perform near-data processing for the cluster and reduce the memory movement, to thereby provide more efficient performance in an improved service mesh cluster architecture. Such an architecture can be used to implement data center clusters with reduced memory movement between hosts, lower latency, improved resource utilization, and lower power consumption, among other example benefits.

In modern computing environments, software services and applications are increasingly deployed in a distributed manner. For instance, an application or service may be deployed and executed across multiple computing systems, with each of the multiple computing systems implementing a component (e.g., a microservice) of the overall service. For instance, an application or service in a service oriented architecture may be implemented according to a microservice architecture. The component microservices may be implemented on machines of differing technologies and may be programmed using different computing languages or technologies. Such architectures may benefit from platform flexibility, programmability, and modularity. Network processing devices, such as IPUs, may be valuable tools in realizing such architectures (e.g., within cloud computing systems, data centers, etc.).

Cloud service providers (CSP), communications service providers (CoSP), and enterprises are investing heavily in hyper-scale data centers to deliver efficient computing for cloud-native applications and micro-services. However, infrastructure services such as storage and networking can consume a significant number of CPU cycles within the computing platforms utilized within such systems, diminishing the overall performance of the system.

Infrastructure Processing Units (IPUs) and other network processing devices may include circuitry to accelerate network and storage infrastructure within cloud and server computing platforms, freeing up CPU cores for improved application performance. For instance, IPUs may be used to provide virtIO-blk/NVMe storage functions to the host thereby offloading such storage services. The IPU effectively hides the backend implementation differences and adaptation needs, offloads the relevant adaptation logic, and more efficiently provides storage for the system. Traditionally, backend storage comes from remote storage service connected through a connection protocol network (e.g., isCSI, Ceph, NVMe-oF).

In one example implementation, an IPU device may include a programmable processing module (e.g., an FPGA module) and a CPU module. In some implementations, the CPU module may be implemented through a system on chip (SoC) device including one or more CPU cores (e.g., Xeon™ CPU). The FPGA and CPU may be utilized together to implement various services and functionality of the IPU.

Commercially important applications, like Large Language Model Inferencing and Similarity Search (used in RAGs) in a large graph are increasingly memory bandwidth dominated with very low arithmetic intensity. These applications may include subsections that are suitable for offload from the CPU to a different compute unit (e.g., a Memory Processing Unit (MPU), infrastructure processing unit (IPU), a hardware accelerator, or other compute unit) specially designed to have very high memory throughput but much lower compute (Flops) than a CPU or GPU. For instance, an MPU may be implemented as specialized computing device configured to perform various tasks (e.g., in an optimized or more efficient manner through hardware acceleration) relating to memory management, memory access, and processing. In some cases, the MPU may combine memory and (memory-focused) processing capabilities within a single device. A CPU or host processor may offload certain memory access and management tasks to an MPU, thereby leveraging the specialized processing capabilities of the MPU, among other example uses. An MPU may be connected to a host process through an interconnect, such as a CXL-based interconnect, using a CXL.mem interface, with the MPU memory cacheable by the host (most of the time). For several reasons (e.g., cost, size of MPU memory, system scalability, system performance) software coherency may be used between the CPU and MPU compute elements instead of the hardware coherency allowed by CXL.cache.

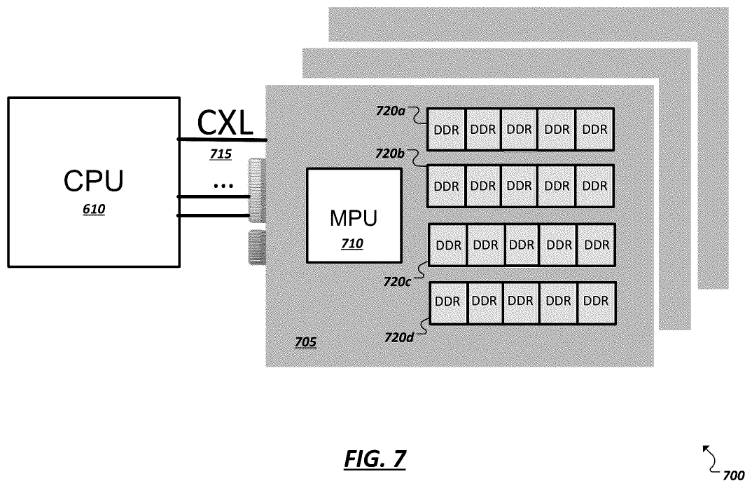

Turning to FIG. 7, a simplified block diagram 700 is shown of an example system including a CPU or other host processor device (e.g., 610) coupled to one or more other compute units, such as one or more MPU devices (e.g., 705). A CPU 610 may couple to an MPU 710 on an MPU device 705 using a respective CXL link 715 (e.g., CXL.mem link) using the respective CXL ports (and accompanying port hardware circuitry) on the CPU and the MPU device (or other device). An MPU device 705 may include an MPU 710 coupled to one or multiple local memory blocks (e.g., 720a-d), with the MPU capable of accessing a processing data on the local memory blocks as “near memory”, enabling acceleration of processing of data on the local memory blocks (e.g., 720a-f) by the MPU 710.

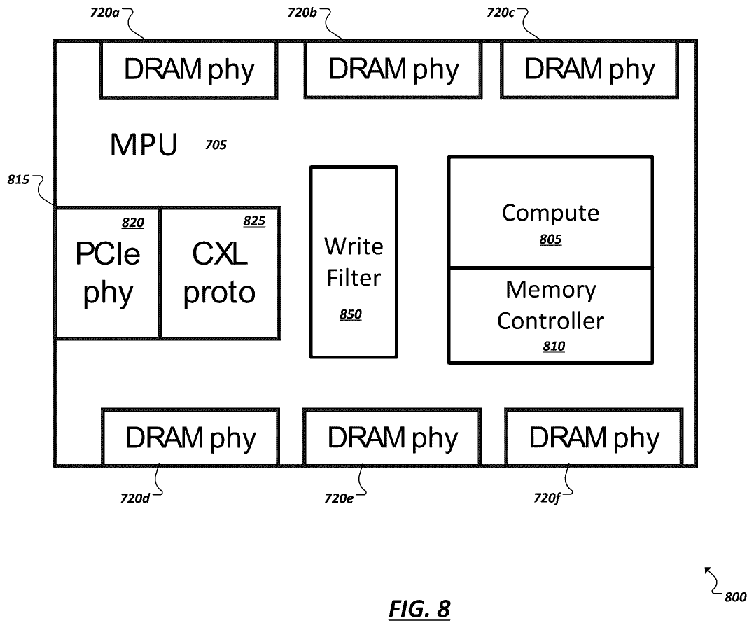

FIG. 8 is a simplified block diagram 800 illustrating an example MPU device 705. An MPU device 705 may include a compute circuitry (e.g., 805) configured to provide a variety of arithmetic and other functions on data stored on local near memory (e.g., 720a-f) accessed by the MPU using memory controller circuitry 810 and the memory interfaces (e.g., DRAM physical layers) corresponding to the near memory blocks (e.g., local DRAM blocks) coupled to and accessible by the MPU. The MPU may include a CXL interface 815 to couple to one or more other devices, such as host processor devices, CPUs, GPUs, IPUs, other MPUs, etc. The CXL port 815 may include PCIe physical layer circuitry 820 and CXL protocol layer circuitry 825 to implement the respective CXL layers and sublayers supported by the MPU (e.g., CXL.mem).

In modern computing systems, including data center systems, speculative reads of CXL memory by the CPU cannot be prevented. If these reads occur while the MPU is, through software coherency agreement, the writer to a given region of CXL memory, then the CPU cache may come to contain stale copies of some of the shared cache lines. Once read, the CPU is free to write this cache line back to CXL memory at any time. In this case, however, the contents of those cache lines written by the MPU will be lost. In a software coherency flow, the CPU cache will need to be invalidated to discard these stale cache lines before the CPU becomes the reader/writer of that region. Unfortunately, traditional mechanisms available for this (e.g., CLFLUSHOPT) can sometimes write these unmodified but stale cache lines to CXL memory, but, again, this causes the contents of those cache lines written by the MPU to be lost. This is known as the clean write back problem. The problem may also exist in the opposite direction for some MPU designs, where clean write backs could occur from the cache in an MPU compute element to the MPU memory.

In an improved system, a system may include an MPU (e.g., 705) or other computing block providing very high memory throughput, which a host processor (or other processing block (e.g., with higher compute resources)) may leverage to offload traffic with high memory bandwidth demands. The system may be improved to integrate logic to address the issue of the clean cache writebacks as articulated above. While the improved features are discussed herein predominantly from the CPU to CXL memory direction, it should be understood that the solution may be similarly applied in the reverse direction as well (e.g., to protect CPU memory from conflicting accelerator memory accesses).

Within the context of CXL, clean cache writeback issues have emerged with the advent of CXL.mem accessible memory shared between multiple CPUs, where each CPU is running a different operating system (OS) instance. While such issues could potentially be mitigated by integrating full hardware coherency through CXL.cache, such an approach may add significant cost, limit system scaling, and may not work for MPUs with large amounts (e.g., 100 GB+) of memory, among other example issues. A Back Invalidate (BI) feature could also be adopted in CXL.mem for use in providing hardware-based coherency, although such a feature would likely also add cost (e.g., to track cache lines) and result in negative performance impacts (e.g., for unnecessary writeback traffic), among other example issues. As still another solution, implementing clean cache writeback in such system could also be pursued by simply making the MPU local memory uncacheable, although the traditional value proposition for MPUs assumes that the MPU memory will be cacheable most if not all of the time (e.g., where the goal of the MPU is to enable the CPU or another MPU to operate on the same data (e.g., load/store) without moving it), among other example considerations and issues.

In an improved system, a programmable write filter (e.g., 850) is integrated with added to, or coupled to an example MPU's CXL interface 815. While the example of FIG. 8 shows the write filter 850 as a part of an example MPU 705, in other example implementations, the write filter 850 may be provided as a separate hardware block, which is coupled to the MPU 705 (or even another accelerator device or memory device) to provide write filtering to protect against writebacks and other conflicting requests by a host system coupled to the MPU and sharing a memory (e.g., 720a-720f) with the MPU 705. Further, while the example of FIG. 8 show the shared memory as integrated with the MPU 705, in other example implementations, the shared memory may be external to the MPU 705, among other examples.

A hardware write filter 850 may enable discarding of writes from the CPU (or host processor) to specific address ranges in a shared memory (e.g., MPU memory). The software coherency flow may be modified with the activation of this write filter when there should not be any CPU writes to a particular memory region. If clean write backs occur then, they are discarded. The filter 850 may be disabled (e.g., entirely or for only a select portion of the shared memory) after the MPU 805 is finished writing to otherwise working in the shared memory (e.g., 720a-f). The write filter 850 can be enabled and disabled very quickly, adding only a negligible delay, or additional latency, to the flow of an MPU work request. Such a filter can be further combined with the per-page writeback control to further shorten the software coherency delays for a complete MPU work request and response. Such a solution may enable the use of CXL.mem as a shared memory protocol between systems running different instances of an OS using software-based coherency. Indeed, existing CXL hardware (e.g., CXL 2.0) may be augmented to support the programmable write filter 850 without including an expensive CXL.cache feature in the accelerator, among other examples. Further, such features enable systems with MPUs to support software coherency and provide huge internal memory bandwidth through the MPU (or other CXL memory associated with an accelerator), which may be coupled with CPUs and the resulting high bandwidth platform to support memory-intensive application, such as Al applications (e.g., large language model (LLM) inferencing), among other examples. Some versions of CXL may include a feature called Back Invalidate that enables hardware coherency between the CPU and the CXL memory. In some implementations, Back Invalidate may be combined (e.g., selectively and dynamically) with a programmable write filter (e.g., 850) to further enhance the coherency management of shared memory, among other example enhancements.

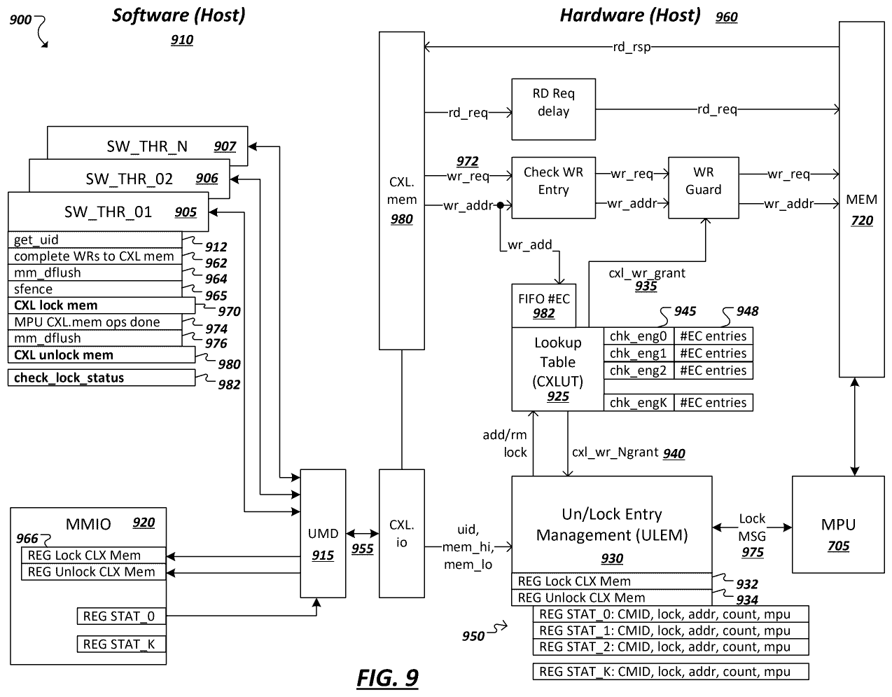

In some implementations, a programmable hardware-based write filter 850 (or other hardware for selectively dropping write attempts to a corresponding memory) may be added and activated to avoid the spontaneous cache line writeback to CXL memory when software coherency rules dictate that such writebacks should not occur. For instance, a host device may write all data to CXL memory (e.g., including memory of an MPU) and perform a flush (e.g., _mm_flush(ptr)) on all writes. The host may further set a store fence (SFENCE) barrier (e.g., _mm_sfence( )) and a “MPU ownership” bit on the CXL device for the memory region of interest (MROI). Here an MPU (e.g., 805) is free to use and modify CXL resident memory contents. Thereafter, host writes to the CXL memory with the MROI may be blocked (e.g., dropped) by the hardware-based write filter 850. As such, write success is returned to the host on the CXL link (e.g., coupling the host to the MPU) avoiding an error condition and a status register in the CXL controller may be used to log a notification of the block action (or a drop). When the MPU 805 finishes its read/write use of CXL memory, the MPU 805 may notify the host device with a completion record. The host may then flush/invalidate the reserved MROI region to eliminate any stale data, wait for the flush to finish, and unlock the memory MRIO region. FIG. 9 is a simplified block diagram 900 illustrating an example of this procedure.

For instance, as shown in FIG. 9, various software threads (e.g., 905, 906, 907) may be running on a host 910. A thread (e.g., 905) may manage both the lock and unlock calls to a CXL-based memory device 960 (e.g., an MPU, CXL memory device, accelerator with attached memory, etc.) over a CXL link 955 (coupling the host 910 to the memory hardware 960). In some implementations, the programmable hardware filter (in hardware 960) may be incorporated and implemented (e.g., placed) at CXL card close to the CXL.MEM IP or at CPU die at front of cache coherent I/O interface pipeline of operations, among other examples. The software thread 905 may register 912 itself in the host user mode driver (UMD) 915 by acquiring a unique identifier (UID). Software also is requested to generate a memory ID (MID) tag for each CXL-allocated memory region. A global tag (CMID) may be generated based on the UID and the MID (e.g., through a concatenation of the UID and MID (e.g., CMID={UID, MID})), among other examples. The UMD 915 may service the memory-mapped I/O (MMIO) CXL device registers 920 mapping and access management by multiple software threads. The UMD 915 may also generate and keep track (e.g., per each software thread) of the UIDs. In one example, the registration may be based on a socket mechanism and is responsible for enqueuing multiple requests. Once the software thread releases the socket then all entries associated with that UID may be removed from a write filter lookup table (CXLUT) 925, and the corresponding UID may be released. The write filter may further include Un/Lock Entry Management (ULEM) hardware circuitry 930 responsible for management of the lock and unlock functionality. The ULEM 930 may be associated with and expose two “public” registers, one for locking 932 (e.g., REG_LOC) and one for unlocking 934 (e.g., REG_UNLOCK), to implement at least a portion of an application programming interface (API) for the UMD 915 to steer lock/unlock entries calls to the write filter. The lookup table 925 is a hardware unit responsible for parallel search of address ranges within the shared memory to identify whether any locks are enabled for one or more of the address ranges and thereby whether to grant the write access permission to a given requested address by setting either a grant 935 (e.g., <cxl_wr_grant>) or refusal or non-grant 940 (e.g., <cxl_wr_Ngrant>) signal. The CXLUT 925 may instantiate one or more search engines 945 (e.g., CHK_ENG_ #) associated with various small batches of device physical address (DPA) (e.g., HI, LO) entries 948 (e.g., #EC entries). The MPU 705, in some implementations, may serve as the main memory bound accelerator. Once notified about the host locked memory region of interest (CMID), it may start its operation(s) on memory 720. Once the task is finished, the MPU 705 may write a “done” bit into a status register 950 (e.g., REG_STAT) associated with a corresponding CMID, among other example implementations.

In some implementations, an lock/unlock operation flow together with associated memory transactions, may include a software thread (e.g., 905) of a host 910 registering itself with the host UMD 915 (e.g., through a get_uid operation 912). The software thread obtains a UID and the UID is used to construct a CMID for every allocated batch of the CXL memory 720. The software then operates normally, including performing writes 962 to memory 720 over the CXL link 955. When the writes are completed, the software thread 905 may request a flush 964 and set a barrier 965 (e.g., SFENCE) to organize writes to the CXL memory device. The MPU 705 will then consume the data (e.g., performing accelerated memory management, pre-processing, or access tasks). The software thread 905 sends a LOCK request 970 to the memory device 960. In one example, the LOCK request 970 includes fields with information including the CMID and the host physical address of the locking memory region (e.g., both the high address and low address in a given range). The UDM 915 may write the request into the memory device 960 (over the CXL link 955) such that the lock request is written to the REG_LOCK_CXL_MEM register 932 (e.g., over MMIO 920 (e.g., at 966)).

Continuing with the example of FIG. 9, the ULEM 930 may decode the MMIO request and store the request data in a free REG_STAT_ #status register 950. The ULEM 930 may then send an ADD call to the CXLUT 925 and send a Lock message 975 to the MPU notifying the MPU to start its operations on given a CMID memory range in memory 720. The CXLUT 925 may find a free slot in the lock/unlock table by storing the CMID alongside HPA_MEM_RANGE_HI/LO addresses. Each write at the CXL.MEM interface 980 may be captured and the write address <wr_addr> is passed to CXLUT FIFO 982 for further processing. The <wr_addr>is pulled from CXLUT FIFO 982 and is processed in parallel by all CHK_ENG_ #engines 945. The search latency may depend on the lookup table #EC gradation. For instance, the smaller number of #EC entries per CHK_ENG_ #945, the lower latency that may be achieved. To enforce the hardware write filter, if a requested (and recorded) LOCK is not associated with a given <wr_addr> of a request, the CXLUT 925 may indicate that the write should be granted (e.g., by setting <cxl_wr_grant> 935). When granted, the write request (e.g., 972) is permitted to proceed to the memory controller of the memory 720. However, if a LOCK is found for a given address <wr_add> of the write request in the CXLUT 925, the CXL write is blocked. For instance, a <cxl_wr_Ngrant> signal 940 is set and the status register REG_STAT for the matched LOCK CMID is updated accordingly (e.g., with information including the last blocked HPA address range (HI/LO) values, the number of captured blocked writes, etc. In cases where the MPU is permitted to finish its operation, the MPU may send a “done” message for a particular CMID and the ULEM 930 updates the corresponding status REG_STAT_ #for the CMID.

Continuing with the preceding example, the software thread 905 may poll the lock status register (e.g., through MMIO 920) to identify when the MPU updates the status register to indicate that the MPU is done. Concluding that the CXL.mem operations are complete (at 974), the software thread 905 may cause a memory flush 976 to be performed and issue a call 980 to unlock the memory range (e.g., through a CXL_UNLOCK_MEM call). This call may be received by the ULEM 930 to remove the lock, for instance, by sending a REMOVE call to the CXLUT 925 to remove the corresponding CMID entry from the table. In some implementations, the thread 905 may request a check_lock_status 982 to verify that the lock has been removed (or, that a previous lock request was successful), among other example implementations and features.

In the above description, the memory regions remain cacheable by the host after a write lock (or write discard) is enabled on the region. While the region remains cacheable, the host cannot prevent memory in that region from being cached. For that reason, the host is responsible for flushing/invalidating the region from its cache before disabling the write discard on the region. This can be completed before the host can read what the MPU wrote to that region, so it adds latency to the completion of an MPU function. In some implementations, software may be enhanced to attempt to eliminate that latency at the cost of such additional OS calls, among other examples.

In one example implementation, software may be utilized to combine a similar write locking feature and CPU page attribute feature to eliminate the need to invalidate on MPU completion. For instance, the process of changing individual pages from WB to uncacheable (UC) or vice versa takes time and has significant overhead. By combining it with the write discard feature the page transition overhead is removed from the region ownership transition path. For instance, the flow in the section above may be modified such as the following: following: a host device may write all data to the CXL memory region and perform a flush (e.g., _mm_cflushopt) on all writes. The host may ensure that the flushes are complete (e.g., through a SFENCE operation (e.g., via _mm_sfence)) and enable write discard on the memory region. The MPU may then begin reading and/or modifying memory in the region. The host may then begin switching pages in the region from writeback (WB) to uncacheable (UC). When all pages have transitioned to UC, the host may then disable write discard on the region. The MPU may finish reading and/or modifying data in the region. The host may begin switching pages in the region from UC back to WB and the host may begin reading and/or modifying the region before page switching completes (e.g., with reduced performance). When all pages have transitioned to WB, the host can access the now unlocked region (e.g., with normal performance).

This software-based technique allows the MPU to use the region as soon as write lock or discard is enabled (e.g., without waiting for pages to become UC). Transitioning the pages from WB to UC occurs in the host while the MPU is using the memory region. Write discard prevents any clean write backs that occur during page transition from reaching CXL memory. The page transition process may complete well before the MPU function. When all the pages in the region are UC, none of that region can be cached by the CPU. As a result, as data cannot be cached in this state, there can be no write backs. This eliminates the need for the flush/invalidate of the region after the MPU completes and before the host resumes reading and/or modifying the region. It also means the write discard feature can be disabled before the MPU function completes. The host can immediately begin reading/writing the region as soon as the MPU completes. It should begin the WB page transition process first to minimize the UC penalty it experiences.

This technique can also be used to increase the granularity of the write discard feature. For instance, if an implementation provided a limited number of write discard regions, and/or the regions had a large granularity, this technique could be used to block writes to a large region while a subset of the pages in that large region was transitioned to UC. Once the subset of pages is UC the write discard filter can be reprogrammed to apply to a different address range, among other example features.

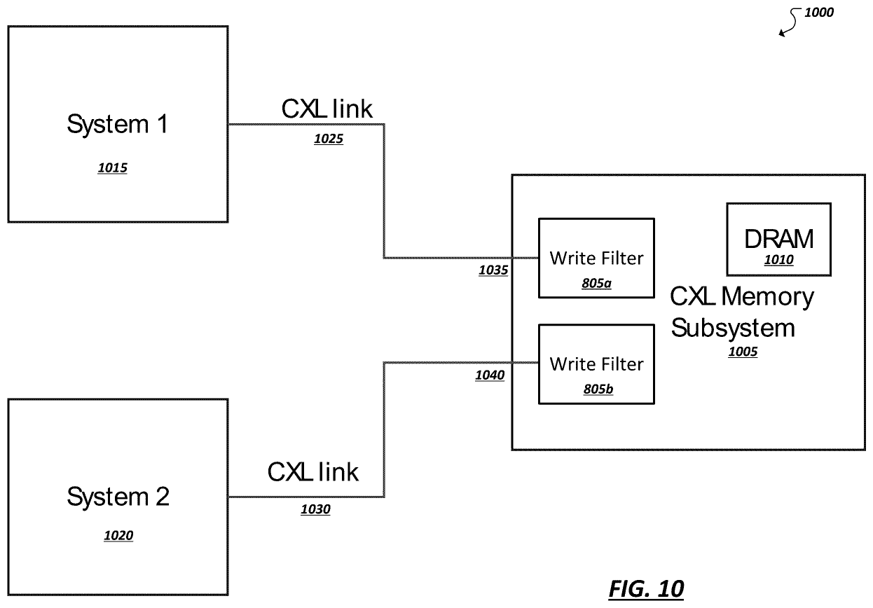

Turning to FIG. 10, a simplified block diagram 1000 is shown of one example configuration including the use of write filter circuitry 850a, 850b to temporarily discard writes to a shared memory 1010 (e.g., on a separate memory device 1005, such as an MPU device, or in memory on the same package as one of the host systems, etc.). In this example, two or more host processor systems (e.g., 1015, 1020), accelerators, or other processor devices (or XPUs) may share the memory 1010, implemented as CXL memory. The respective processor devices may couple to the memory device using respective CXL links (e.g., 1025, 1030). A respective write filter hardware block (e.g., 850a, 850b) may be provided for each of the CXL ports (e.g., 1035, 1040) of the memory subsystem 1005 to selectively control and discard writes by the respective processor devices coupled to the memory subsystem by the corresponding CXL ports, such as discussed above, among other example configurations. In some implementations, the respective write filter blocks 805a, 805b may be implemented as a single write filter block with a single lookup table un/lock entry manager, etc., but coupled to multiple CXL links. In some implementations, write filter blocks 805a, 805b may be independently controlled so as to selectively block writes to selected address ranges in the shared memory 1010 on either CXL link 1025 (from host 1015) or CXL link 1030 (from host 1020). In some implementations, the processor devices 1015, 1020 may each be capable of sending writeback requests to the memory or otherwise interfere with the other's access of the memory and its coherency management. The write filters 805a, 805b may be leveraged by the processor device 1015, 1020 to protect against such issues, among other example considerations and features.

Note that the apparatus', methods', and systems described above may be implemented in any electronic device or system as aforementioned. As a specific illustration, FIG. 8 provides an exemplary implementation of a processing device such as one that may be included in a network interface device. It should be appreciated that other processor architectures may be provided to implement the functionality and processing of requests by an example network interface device, including the implementation of the example network interface device components and functionality discussed above. Further, while the examples discussed above focus on the use of CXL and CXL-based protocols, it should be appreciated that reference to CXL is as an illustrative example only. Indeed, the more generalized concepts disclosed herein may be equally and advantageously applied to other interconnects and interconnect protocols that facilitate similar features, among other examples.

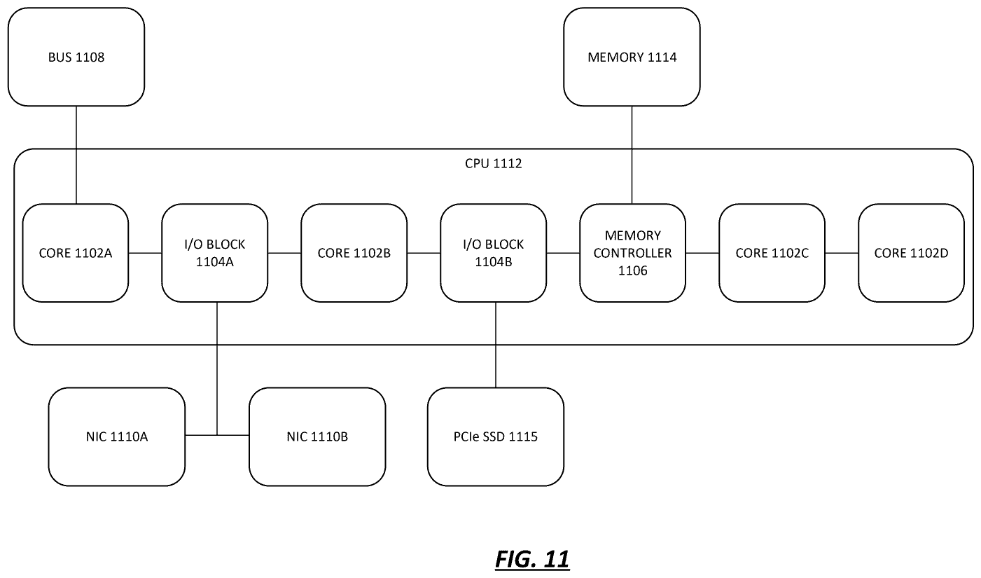

Referring to FIG. 11, a block diagram is shown of an example data processor device (e.g., a central processing unit (CPU)) 1112 coupled to various other components of a platform in accordance with certain embodiments, such as those discussed above. Although CPU 1112 depicts a particular configuration, the cores and other components of CPU 1112 may be arranged in any suitable manner. CPU 1112 may comprise any processor or processing device, such as a microprocessor, an embedded processor, a digital signal processor (DSP), a network processor, an application processor, a co-processor, a system on a chip (SOC), or other device to execute code. CPU 1112, in the depicted embodiment, includes four processing elements (cores 1102 in the depicted embodiment), which may include asymmetric processing elements or symmetric processing elements. However, CPU 1112 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1112, as illustrated in FIG. 11, includes four cores-cores 1102A, 1102B, 1102C, and 1102D, though a CPU may include any suitable number of cores. Here, cores 1102 may be considered symmetric cores. In another embodiment, cores may include one or more out-of-order processor cores or one or more in-order processor cores. However, cores 1102 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1102 may include a decode module coupled to a fetch unit to decode fetched elements. Fetch logic, in one embodiment, includes individual sequencers associated with thread slots of cores 1102. Usually, a core 1102 is associated with a first ISA, which defines/specifies instructions executable on core 1102. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 1102 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1102, in one embodiment, recognize the same ISA (or a subset thereof). Alternatively, in a heterogeneous core environment, a decoder of one or more cores (e.g., core 1102B) may recognize a second ISA (either a subset of the first ISA or a distinct ISA).

In various embodiments, cores 1102 may also include one or more arithmetic logic units (ALUs), floating point units (FPUs), caches, instruction pipelines, interrupt handling hardware, registers, or other suitable hardware to facilitate the operations of the cores 1102.

Bus 1108 may represent any suitable interconnect coupled to CPU 1112. In one example, bus 1108 may couple CPU 1112 to another CPU of platform logic (e.g., via UPI). I/O blocks 1104 represents interfacing logic to couple I/O devices 1110 and 1115 to cores of CPU 1112. In various embodiments, an I/O block 1104 may include an I/O controller that is integrated onto the same package as cores 1102 or may simply include interfacing logic to couple to an I/O controller that is located off-chip. As one example, I/O blocks 1104 may include PCIe interfacing logic. Similarly, memory controller 1106 represents interfacing logic to couple memory 1114 to cores of CPU 1112. In various embodiments, memory controller 1106 is integrated onto the same package as cores 1102. In alternative embodiments, a memory controller could be located off chip.

As various examples, in the embodiment depicted, core 1102A may have a relatively high bandwidth and lower latency to devices coupled to bus 1108 (e.g., other CPUs 1112) and to NICs 1110, but a relatively low bandwidth and higher latency to memory 1114 or core 1102D. Core 1102B may have relatively high bandwidths and low latency to both NICs 1110 and PCIe solid state drive (SSD) 1115 and moderate bandwidths and latencies to devices coupled to bus 1108 and core 1102D. Core 1102C would have relatively high bandwidths and low latencies to memory 1114 and core 1102D. Finally, core 1102D would have a relatively high bandwidth and low latency to core 1102C, but relatively low bandwidths and high latencies to NICs 1110, core 1102A, and devices coupled to bus 1108.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a hardware write filter including circuitry to: receive a signal to switch the hardware write filter from a disabled state to an enabled state; identify a write attempt by a host processor to a memory region associated with an accelerator device; and cause the write attempt to be dropped when the hardware write filter is in the enabled state.

Example 2 includes the subject matter of example 1, where the write attempt includes a write attempt based on a Compute Express Link (CXL) protocol.

Example 3 includes the subject matter of example 2, where the write attempt is communicated over a link coupling the host processor and the accelerator device, and the link is compliant with the CXL protocol.

Example 4 includes the subject matter of any one of examples 2-3, where the CXL protocol includes CXL.mem.

Example 5 includes the subject matter of any one of examples 1-4, where the hardware write filter includes an interface to receive programming instructions to configure the hardware write filter to drop write attempts to the memory region.

Example 6 includes the subject matter of example 5, where the hardware write filter includes circuitry to: identify another write attempt by the host processor to another memory region associated with the accelerator device; determine that the hardware write filter is disabled for the other memory region; and allow the other write attempt to the other memory region to complete while the hardware write filter is enabled for the memory region.

Example 7 includes the subject matter of any one of examples 1-5, where the accelerator device includes a memory processing unit (MPU).

Example 8 includes the subject matter of example 6, where the MPU includes a memory, and the memory includes the memory region.

Example 9 includes the subject matter of any one of examples 1-7, where the hardware write filter is integrated with the accelerator device.

Example 10 includes the subject matter of any one of examples 1-7, where the hardware write filter is separate from the accelerator device and is to be coupled to an interface of the accelerator device.

Example 11 includes the subject matter of any one of examples 1-10, where the hardware write filter is to discard clean writeback attempts by the host processor.

Example 12 includes the subject matter of any one of examples 1-11, where the write attempt includes a writeback attempt.

Example 13 includes the subject matter of any one of examples 1-12, where the signal is based on a lock request from the host processor, and the hardware write filter includes circuitry to: identify that the accelerator device has completed work in the memory region; indicate to the host processor that the accelerator device has completed work in the memory region; receive an unlock request from the host processor for the memory region; and disable the hardware write filter for the memory region based on the unlock request.

Example 14 is a method including: receiving a signal, at a hardware write filter coupled to an accelerator device, to place the hardware write filter in an enabled state for an address range in a memory associated with the accelerator device; identifying, at the hardware write filter, a write attempt to the address range region by a host processor over a link, where the link enables communication between the accelerator device and the host processor; and preventing the write attempt using the hardware write filter.

Example 15 includes the subject matter of example 14, where the hardware write filter is in a disabled state for at least one other address range in the memory while the hardware write filter is in the enabled state for the address range, where writes are allowed to progress to the other address range while the while the hardware write filter in the disabled state for the other address range.

Example 16 includes the subject matter of any one of examples 14-15, where the signal includes a first signal, and the method further includes receiving a second signal at the hardware write filter to place the hardware write filter in a disabled state for the address range, where the hardware write filter allows write attempts by the host processor to the address range when in the disabled state.

Example 17 includes the subject matter of any one of examples 14-16, further including receiving one or more signals to program the hardware write filter to prevent write attempts by the host processor to a specific memory range associated with the address range while the hardware write filter is in an enabled state.

Example 18 includes the subject matter of any one of examples 14-17, further including: identifying, at the hardware write filter, that the accelerator device has completed work in the address range; and indicating to the host processor that the accelerator device has completed work in the address range.

Example 19 includes the subject matter of any one of examples 14-18, further including: receiving an unblock signal at the hardware write filter from the host processor, where the unblock signal identifies the address range; and disable the hardware write filter for the address range based on the unlock signal.

Example 20 includes the subject matter of any one of examples 14-19, where the write attempt includes a clean writeback.

Example 21 includes the subject matter of any one of examples 14-20, where the write attempt is based on a CXL-based protocol.

Example 22 includes the subject matter of any one of examples 14-21, where the hardware write filter includes the apparatus of any one of examples 1-13.

Example 23 is a system including means to perform the method of any one of examples 14-22.

Example 24 is a method including: completing a write to an address in an address range in a shared memory, where the shared memory is accessed via an interconnect link; sending a lock signal over the interconnect link to a write filter device associated with the shared memory, where the lock signal identifies the address range to cause the write filter device to create a lock for the address range, where write requests from a host processor to the address range are to be blocked based on the lock; receiving an indication that another device has completed use of the address range; and sending an unlock signal over the interconnect link to the write filter device to cause the write filter device to remove the lock.

Example 25 includes the subject matter of example 24, where the interconnect link is compliant with a CXL-based protocol.

Example 26 includes the subject matter of any one of examples 24-25, where the lock is to block writeback requests to the address range from the host processor over the interconnect link.

Example 27 includes the subject matter of example 26, where writeback requests are allowed by the write filter device for one or more other address ranges in the shared memory while the lock is active.

Example 28 includes the subject matter of any one of examples 24-27, where the other device includes a memory processing device.

Example 29 includes the subject matter of any one of examples 24-28, where the lock signal further includes an identifier of a software thread executed by the host processor.

Example 30 includes the subject matter of any one of examples 24-29, further including accessing information in a register of the write filter device to identify a number of write requests blocked by the write filter device based on the lock.

Example 31 is a system including means to perform the method of any one of examples 24-30.

Example 32 includes the subject matter of examples 31, where the means include a non-transitory computer readable storage medium with instruction stored thereon, the instructions executable by a processor to perform at least a portion of the method of any one of examples 24-30.

Example 33 is a system including: a host processor; a hardware accelerator, where the hardware accelerator is coupled to the host processor by a link; a memory associated with the hardware accelerator; and a programmable hardware write filter to selectively discard writes by the host processor to a select region in the memory.

Example 34 includes the subject matter of example 33, further including software to be executed by the host processor to manage coherency of the memory.

Example 35 includes the subject matter of any one of examples 33-34, where the hardware accelerator includes the memory.

Example 36 includes the subject matter of any one of examples 33-35, where the hardware accelerator includes a memory processing unit (MPU).

Example 37 includes the subject matter of any one of examples 33-36, where the programmable hardware write filter is to: receive a signal to switch the hardware write filter from a disabled state to an enabled state; identify a write attempt by a host processor to a memory region in the memory; and cause the write attempt to be dropped when the hardware write filter is in the enabled state.

Example 38 includes the subject matter of example 37, where the write attempt includes a write attempt based on a Compute Express Link (CXL) protocol.

Example 39 includes the subject matter of example 38, where the write attempt is communicated over a link coupling the host processor and the accelerator device, and the link is compliant with the CXL protocol.

Example 40 includes the subject matter of any one of examples 33-39, where the CXL protocol includes CXL.mem.

Example 41 includes the subject matter of any one of examples 33-40, where the programmable hardware write filter includes an interface to receive programming instructions to configure the hardware write filter to drop write attempts to the specific memory region.

Example 42 includes the subject matter of any one of examples 33-41, where the accelerator device includes a memory processing unit (MPU).

Example 43 includes the subject matter of example 42, where the MPU includes the memory.

Example 44 includes the subject matter of any one of examples 33-43, where the hardware write filter is integrated with the accelerator device.

Example 45 includes the subject matter of any one of examples 33-43, where the hardware write filter is separate from the accelerator device and to be coupled to an interface of the accelerator device.

Example 46 includes the subject matter of any one of examples 33-45, where the programmable hardware write filter is to discard clean writeback attempts.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a hardware write filter comprising circuitry to:
receive a signal to switch the hardware write filter from a disabled state to an enabled state for a portion of a shared memory associated with an accelerator device;
identify a write attempt by a host processor to the portion of the shared memory, wherein the write attempt comprises a clean writeback attempt; and
cause the write attempt to be dropped when the hardware write filter is in the enabled state for the portion of the shared memory.

2. The apparatus of claim 1, wherein the write attempt comprises a write attempt based on a Compute Express Link (CXL) protocol.

3. The apparatus of claim 2, wherein the write attempt is communicated over a link coupling the host processor and the accelerator device, and the link is compliant with the CXL protocol.

4. The apparatus of claim 2, wherein the CXL protocol comprises CXL.mem.

5. The apparatus of claim 1, wherein the hardware write filter comprises an interface to receive programming instructions to configure the hardware write filter to drop write attempts to the portion of the shared memory.

6. The apparatus of claim 1, wherein the hardware write filter comprises circuitry to:
identify another write attempt by the host processor to another portion of the shared memory;
determine that the hardware write filter is disabled for the other portion of the shared memory; and
allow the other write attempt to the other portion of the shared memory to complete while the hardware write filter is enabled for the portion of the shared memory.

7. The apparatus of claim 6, wherein the other write attempt comprises a writeback attempt to the other portion of the shared memory.

8. The apparatus of claim 1, wherein the accelerator device comprises a memory processing unit (MPU).

9. The apparatus of claim 8, wherein the MPU comprises a memory, and the memory comprises the memory region.

10. The apparatus of claim 1, wherein the hardware write filter is integrated with the accelerator device.

11. The apparatus of claim 1, wherein the hardware write filter is separate from the accelerator device and is to be coupled to an interface of the accelerator device.

12. The apparatus of claim 1, wherein the signal is based on a lock request from the host processor, and the hardware write filter comprises circuitry to:
identify that the accelerator device has completed work in the portion of the shared memory;
indicate to the host processor that the accelerator device has completed work in the portion of the shared memory;
receive an unlock request from the host processor for the portion of the shared memory; and
disable the hardware write filter for the portion of the shared memory based on the unlock request.

13. A method comprising:
receiving a signal, at a hardware write filter coupled to an accelerator device, to place the hardware write filter in an enabled state for an address range in a shared memory associated with the accelerator device;
identifying, at the hardware write filter, a write attempt to the address range region by a host processor over a link, wherein the link enables communication between the accelerator device and the host processor; and
preventing the write attempt using the hardware write filter while the hardware write filter is in the enabled state for the address range.

14. The method of claim 13, wherein the hardware write filter is in a disabled state for at least one other address range in the memory while the hardware write filter is in the enabled state for the address range, wherein writes are allowed to progress to the other address range while the hardware write filter is in the disabled state for the other address range.

15. The method of claim 13, further comprising:
identifying, at the hardware write filter, that the accelerator device has completed work in the address range; and
indicating to the host processor that the accelerator device has completed work in the address range.

16. A system comprising:
a host processor;
a hardware accelerator, wherein the hardware accelerator is coupled to the host processor by a link;
a memory associated with the hardware accelerator, wherein the host processor accesses the memory via an interconnect link; and
a programmable hardware write filter to selectively discard clean writeback attempts by the host processor to a select region in the memory.

17. The system of claim 16, further comprising software to be executed by the host processor to manage coherency of the memory.

18. The system of claim 17, wherein the software is executable to:
complete a write to the select region in the memory;
send a lock signal over the interconnect link to the hardware write filter device to cause the write filter device to discard writes by the host processor to the select region in the memory;
identify that hardware accelerator has completed use of the select region in the memory while the hardware write filter discards writes by the host processor; and
send an unlock signal over the interconnect link to the hardware write filter to cause the hardware write filter to again allow writes to the select region in the memory.

19. The system of claim 16, wherein the hardware accelerator comprises a memory processing unit (MPU).

20. The system of claim 16, wherein the interconnect link is based on a Compute Express Link (CXL) protocol.
